(19) United States
(12) Patent Application Publication
(10) Pub. No.: US 2024/0066341 A1
(43) Pub. Date: Feb. 29, 2024

(54) PROCESSING SYSTEM AND PROCESSING METHOD

(71) Applicant: Tokyo Electron Limited, Tokyo (JP)

(72) Inventor: Shinji Kobayashi, Koshi City (JP)

(21) Appl. No.: 18/454,948

(22) Filed: Aug. 24, 2023

(30) Foreign Application Priority Data
Aug. 25, 2022 (JP) 2022-133887
Apr. 27, 2023 (JP) 2023-073453

(51) Int. Cl. A62D 3/36; A62D 3/38; B01D 1/20; B01D 53/00; B01D 61/02; B01D 61/14

(52) U.S. Cl. CPC A62D 3/36; A62D 3/38; B01D 1/20; B01D 53/002; B01D 61/025; B01D 61/145; A62D 2101/22; B01D 2258/0216

(57) ABSTRACT

A PFAS detoxification system 1 includes a concentrator 11 configured to concentrate a waste liquid containing PFAS, discharged from a semiconductor manufacturing apparatus 100; a sulfuric acid processing tub 12 configured to decompose and evaporate a concentrated liquid concentrated by the concentrator 11 with a liquid containing concentrated sulfuric acid; and a cooling apparatus 13 configured to liquefy and collect a gas evaporated by the sulfuric acid processing tub 12.

### CROSS-REFERENCE TO RELATED APPLICATION

This application claims the benefit of Japanese Patent Application Nos. 2022-133887 and 2023-073453 filed on Aug. 25, 2022 and Apr. 27, 2023, respectively, the entire disclosures of which are incorporated herein by reference.

### TECHNICAL FIELD

The various aspects and exemplary embodiments described herein pertain generally to a processing system and a processing method.

### BACKGROUND

Patent Document 1 describes a draining system including a processing apparatus for reducing a content of an organic fluorine compound or the like, an anion exchange tower filled with an ion exchanger including an anion exchanger, and a decomposing apparatus for decomposing a regenerated liquid flown through the anion exchange tower.

Patent Document 1: Japanese Patent Laid-open Publication No. 2010-125352

### SUMMARY

In an exemplary embodiment, a processing system includes a concentrating unit configured to concentrate a waste liquid containing an organic fluorine compound, discharged from a semiconductor manufacturing apparatus; a chemical liquid processing unit configured to decompose and evaporate a concentrated liquid concentrated by the concentrating unit with a liquid containing concentrated sulfuric acid; and a collecting unit configured to liquefy and collect a gas evaporated by the chemical liquid processing unit.

The foregoing summary is illustrative only and is not intended to be any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a configuration view of a PFAS detoxification system according to an exemplary embodiment;

FIG. 2 is a schematic diagram illustrating an example of a sulfuric acid processing tub and a cooling apparatus;

FIG. 3 is a schematic diagram illustrating another example of the sulfuric acid processing tub and the cooling apparatus;

FIG. 4 is a flowchart illustrating a PFAS detoxification processing;

FIG. 5 is a configuration view of a PFAS detoxification system according to a modification example;

FIG. 6 is a schematic diagram of a sulfuric acid processing tub according to the modification example;

FIG. 7A to FIG. 7E are diagrams illustrating images of a first processing in the sulfuric acid processing tub;

FIG. 8A to FIG. 8E are diagrams illustrating images of a second processing in the sulfuric acid processing tub; and

FIG. 9A to FIG. 9E are diagrams illustrating images of a third processing in the sulfuric acid processing tub.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current exemplary embodiment. Still, the exemplary embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Hereinafter, exemplary embodiments will be described in detail with reference to the accompanying drawings. In the following description, same parts or parts having same functions will be assigned same reference numerals, and redundant description thereof will be omitted.

A processing system according to an exemplary embodiment is a PFAS detoxification system 1 configured to detoxify PFAS discharged from a semiconductor manufacturing apparatus 100. The PFAS refers to a perfluoroalkyl substance and a polyfluoroalkyl compound (Per-and PolyFluoroAlkyl Substances) which are organic fluorine compounds.

The PFAS is a compound containing at least one —CF2- or —CF3 aliphatic molecule, and also includes an organic high molecular compound (polymer) such as Teflon. PFOS (Per Fluoro Octane Sulfonic Acid) and PFOA (Per Fluoro Octanoic Acid) are types of the PFAS. The PFOS is contained in, for example, foam fire extinguishing agent, plating liquids, aircraft hydraulic oils, water repellents, floor waxes, and the like. The PFOA is contained in, for example, textiles, medical products, electronic substrates, automobiles, food wrapper, stone materials, flooring, leather, and the like. In a semiconductor manufacturing process, non-polymer PFAS is used as a photoresist, for example. Further, polymer PFAS is used as liquid contact members such as a pipeline, a valve, and a pump of a semiconductor manufacturing apparatus, a photoresist, an antireflection film, and the like.

The PFAS is stable in nature to be difficult to decompose. Therefore, the PFAS is highly persistent and tends to be easily accumulated in a living body, so that it is highly harmful. The PFAS detoxification system 1 according to the present exemplary embodiment is configured to detoxify the PFAS discharged from the semiconductor manufacturing apparatus 100, thus suppressing the PFAS from being discharged to the outside.

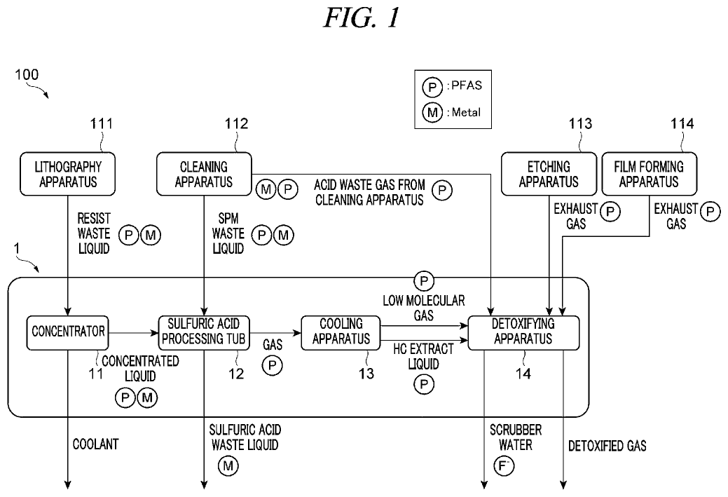

As shown in FIG. 1, the PFAS detoxification system 1 includes a concentrator 11 (concentrating unit), a sulfuric acid processing tub 12 (chemical liquid processing unit), a cooling apparatus 13 (collecting unit), and a detoxifying apparatus 14 (detoxifying unit). In the present exemplary embodiment, the PFAS detoxification system 1 is described as being a device group including a plurality of apparatuses, but the PFAS detoxification system 1 may be composed of a single apparatus. Further, the semiconductor manufacturing apparatus 100 includes a lithography apparatus 111, a cleaning apparatus 112, an etching apparatus 113, and a film forming apparatus 114. Each component of the semiconductor manufacturing apparatus 100 discharges a substance containing the PFAS in a processing performed thereby. In addition, the individual processing units constituting the PFAS detoxification system 1 may or may not be provided in the same space (location). For example, the individual processing units may be provided in a building where the lithography apparatus 111, the cleaning apparatus 112, or the etching apparatus 113 is provided, or may be provided outside the building or in an adjacent space. The individual processing units may be provided separately from each other inside and outside the building. Further, among the concentrator 11, the sulfuric acid processing tub 12, the cooling apparatus 13, and the detoxifying apparatus 14, the one(s) not used need not always be provided.

The lithography apparatus 111 includes a coating and developing apparatus, and an exposure apparatus. Alternatively, the lithography apparatus 111 does not have to include the exposure apparatus, but may be composed of the coating and developing apparatus alone. Still alternatively, the lithography apparatus 111 may be composed of a coating apparatus or a developing apparatus alone. The exposure apparatus is configured to perform an exposure processing of a resist film. Specifically, the exposure apparatus radiates an energy ray to an exposure target portion of the resist film (photosensitive film) by a method such as immersion exposure. The coating and developing apparatus is configured to perform a processing of forming the resist film on a surface of a substrate before the exposure processing by the exposure apparatus, and perform a developing processing of the resist film after the exposure processing. A liquid or a gas discharged from this lithography apparatus 111 contains the PFAS. By way of example, the PFAS is contained in a resist waste liquid, an alkaline waste liquid caused by the developing processing, an acid waste liquid caused by resist peeling, an organic exhaust, a heat exhaust, a solidified sublimate, and the like. In the present exemplary embodiment, the PFAS contained in the resist waste liquid will be mainly discussed. An example of the PFAS contained in the resist waste liquid may be, by way of example, a PAG (Photo Acid Generator). The resist waste liquid discharged from the lithography apparatus 111 is introduced into the concentrator 11 of the PFAS detoxification system 1.

The cleaning apparatus 112 is configured to perform a cleaning processing on the substrate. To remove an organic substance such as the resist, the cleaning apparatus 112 uses, for example, SPM (Sulfuric Acid Hydrogen Peroxide Mixture) in which H₂O₂ and sulfuric acid are mixed. Further, the cleaning apparatus 112 uses a mixed aqueous solution (SC2: Standard Clean 2) in which H₂O₂ and hydrochloric acid are mixed to remove a metal, and uses a mixed aqueous solution (SC1) in which H₂O₂ and ammonia are mixed to remove a particle. In addition, only concentrated sulfuric acid is discharged during a waste liquid treatment. The cleaning apparatus 112 discharges a SPM waste liquid containing the PFAS. The SPM waste liquid and the concentrated sulfuric acid discharged from the cleaning apparatus 112 are introduced into the sulfuric acid processing tub 12. Further, the cleaning apparatus 112 discharges an acid waste gas containing the PFAS. The acid waste gas discharged from the cleaning apparatus 112 is introduced into the detoxifying apparatus 14.

The etching apparatus 113 is configured to perform an etching processing of etching an oxide film/thin film along a pattern of the formed resist film. The etching apparatus 113 discharges an exhaust gas containing the PFAS. The exhaust gas discharged from the etching apparatus 113 is introduced into the detoxifying apparatus 14.

The film forming apparatus 114 is configured to form a wiring film and an insulating film on the substrate. The film forming apparatus 114 uses various kinds of processing gases (containing or not containing the PFAS), and discharges an exhaust gas thereof. The exhaust gas discharged from the film forming apparatus 114 is introduced into the detoxifying apparatus 14.

The concentrator 11 is configured to concentrate the resist waste liquid containing the PFAS discharged from the lithography apparatus 111 of the semiconductor manufacturing apparatus 100. That is, the concentrator 11 concentrates the substrate processing waste liquid of the lithography apparatus 111 as the waste liquid containing the PFAS. The concentrator 11 uses, for example, an ultrafiltration membrane or a reverse osmosis membrane to concentrate the resist waste liquid and separate a solvent contained in the resist waste liquid. Since the concentrated liquid of the resist waste liquid contains a polymer, it has high viscosity. The concentrated liquid of the resist waste liquid is introduced into the sulfuric acid processing tub 12. If the alkaline waste liquid discharged from the lithography apparatus 111 is concentrated by the concentrator 11, the alkaline waste liquid may be introduced into the reverse osmosis membrane after being neutralized.

The solvent separated from the resist waste liquid may be used, as a recycled solvent, in a cup cleaning in the semiconductor manufacturing apparatus 100, or may be collected by a solvent recovery company. Conventionally, when the solvent recovery company performs component analysis when purifying the recycled solvent from the resist waste liquid, there is a risk that a waste liquid containing a confidential substance of a resist maker may also be collected. However, since the concentrated liquid of the resist waste liquid having passed through the concentrator 11 as in the present exemplary embodiment contains a solid component, the leakage of the confidential information to the solvent recovery company can be suppressed.

The sulfuric acid processing tub 12 is configured to decompose and evaporate the concentrated liquid concentrated by the concentrator 11 with the SPM waste liquid. That is, the sulfuric acid processing tub 12 uses the SPM waste liquid of the cleaning apparatus 112. In the SPM waste liquid, a solvent and a polymer undergo a decomposition reaction of a dehydration reaction or an oxidation reaction to have a low molecular weight (low viscosity). At this time, the temperature of the SPM waste liquid increases due to an exothermic reaction (the temperature of the concentrated sulfuric acid in the SPM waste liquid increases). Although the PFAS is not basically decomposed, a component thereof such as the PAG evaporates due to the SPM waste liquid of the high temperature because of its low boiling point (in particular, the component evaporates due to the effect of the concentrated sulfuric acid contained in the SPM waste liquid). At that time, the PFAS also evaporates together. Conventionally, the waste liquid treatment of the SPM waste liquid is performed by adding catalase thereto to suppress foaming. If the SPM waste liquid is made to react with an organic matter in the sulfuric acid processing tub 12 and is thus degassed as a result of using up the H₂O₂ components, a sulfuric acid waste liquid on the downstream side does not foam and can be processed easily. Further, the consumption amount of the catalase can be reduced. Since this reaction generates, for example, heat of about 300° C., thermal difference generation using exhaust heat or steam power generation using steam generated from the circulating water for cooling the sulfuric acid processing tub 12 may be performed. Furthermore, the sulfuric acid waste liquid discharged from the sulfuric acid processing tub 12 is collected by, for example, a recycling company. This sulfuric acid waste liquid may have higher purity of the sulfuric acid than a conventional waste liquid. Moreover, in order to suppress unexpected ignition, it is desirable to carry out the processing in the sulfuric acid processing tub 12 in an atmosphere of a nitrogen gas which is an inert gas. In addition, the SPM waste liquid may be a concentrated sulfuric acid waste liquid. In the case of the concentrated sulfuric acid, a decomposition reaction of a dehydration reaction occurs by the solvent and the polymer to have a low molecular weight (lower viscosity). At this time, the temperature of the concentrated sulfuric acid increases due to an exothermic reaction, causing the PFAS, the PAG, and the like to evaporate.

As the SPM waste liquid collected in the sulfuric acid processing tub 12 is processed by adding the concentrated liquid of the resist waste liquid thereto, the H₂O₂ is gradually consumed, so that a processing capacity is lowered. After supplying an appropriate amount of the concentrated liquid of the resist waste liquid, the sulfuric acid processing tub 12 is put on standby until the reaction subsides and generation of a gas is completed. Since the amount of the SPM waste liquid from the cleaning apparatus 112 is large, the SPM waste liquid from the cleaning apparatus 112 also needs to be processed without delay. For this reason, the sulfuric acid processing tub 12 may be composed of a plurality of processing tubs. In this case, while a processing is being performed in one processing tub, preparation such as supply of a liquid may be performed in another processing tub. Further, while monitoring the degree of progress of the reaction, the liquid may be flown downstream, such as in the order of a first processing tub, a second processing tub, and then a third processing tub. In case that the resist waste liquid is a metal-containing resist, only a metal component is precipitated without evaporating to be processed together with the sulfuric acid waste liquid through the same processes as described above.

Since the SPM waste liquid contains hydrogen peroxide solution, if it is discharged as it is, it may foam and put a burden on the apparatus, or may deteriorate the environment with a foaming gas. In the configuration according to the present exemplary embodiment, however, since the remaining hydrogen peroxide solution is effectively utilized and the foaming gas is burned as a fuel in the detoxifying apparatus 14, the burden on the apparatus and the environment can be reduced.

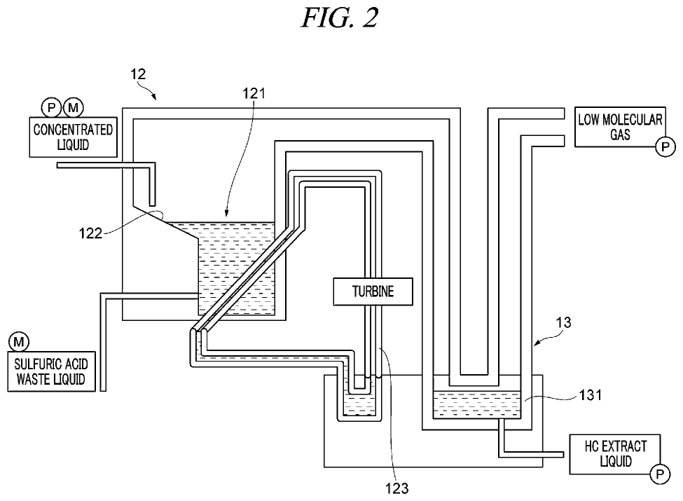

FIG. 2 is a schematic diagram illustrating an example of the sulfuric acid processing tub 12 and the cooling apparatus 13. In the example shown in FIG. 2, the sulfuric acid processing tub 12 and the cooling apparatus 13 are configured as a continuous structure. The sulfuric acid processing tub 12 includes a sulfuric acid reservoir 121 (first reservoir) in which the SPM waste liquid of the cleaning apparatus 112 is stored, and an inclined member 122 continuous with the sulfuric acid reservoir 121 and extending in an inclined shape. In the sulfuric acid processing tub 12, the concentrated liquid concentrated by the concentrator 11 is dripped onto the inclined member 122. The inclined member 122 receives the dripped concentrated liquid to guide this concentrated liquid toward the sulfuric acid reservoir 121. If the concentrated liquid is supplied into a large amount of sulfuric acid, a violent reaction may occur, which is dangerous. In the present exemplary embodiment, however, since the concentrated liquid is dripped onto the inclined member 122, the amount of the concentrated liquid that comes into contact with the sulfuric acid at the edge thereof on the inclined member 122 is limited. Therefore, the occurrence of the violent reaction can be suppressed. In the sulfuric acid processing tub 12, a turbine 123 may be driven by the heat generated through the reaction to generate electricity. The gas containing the PFAS evaporated by the concentrated sulfuric acid flows toward the cooling apparatus 13. Further, when adding the concentrated liquid to the sulfuric acid processing tub 12, the concentrated liquid and nitrogen may be discharged through a two-fluid spray nozzle in order to suppress the violent reaction. By making the concentrated sulfuric acid into small droplets, it becomes easy for the concentrated sulfuric acid to evaporate before reaching a liquid surface of the SPM waste liquid, and, further, a large contact interface is not formed when the concentrated sulfuric acid reacts on the liquid surface of the SPM waste liquid, so that the reaction can be made a relatively gentle reaction. Further, by supplying the nitrogen, the unexpected ignition can be suppressed.

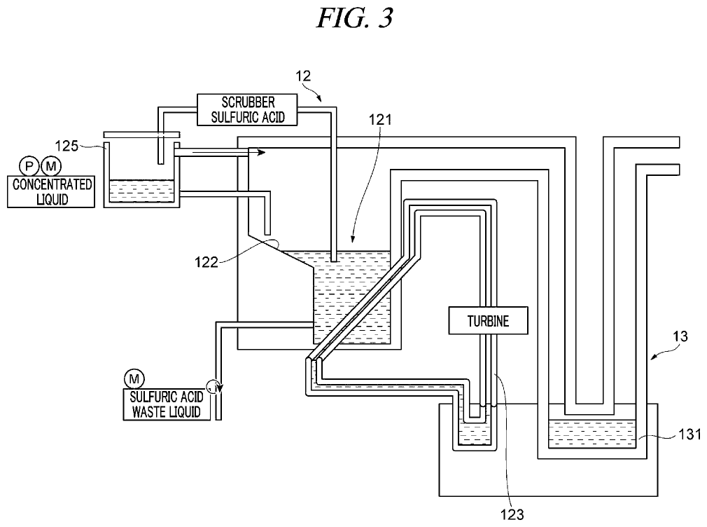

FIG. 3 is a schematic view illustrating another example of the sulfuric acid processing tub 12 and the cooling apparatus 13. In the example shown in FIG. 3, the sulfuric acid processing tub 12 further includes a concentrated liquid reservoir 125 (second reservoir) in which the concentrated liquid is stored. In the concentrated liquid reservoir 125, a predetermined amount of SPM waste liquid from the cleaning apparatus 112 is added to and mixed with the concentrated liquid, and the mixed liquid flows into the sulfuric acid reservoir 121 via the inclined member 122. In this way, in the concentrated liquid reservoir 125, the SPM waste liquid and the concentrated liquid are mixed to the extent that no violent reaction occurs, and the mixed liquid flows into the sulfuric acid reservoir 121 via the inclined member 122. Accordingly, the reaction between the SPM waste liquid and the concentrated liquid can be effectively accelerated.

Referring back to FIG. 1, the cooling apparatus 13 is configured to liquefy and collect the gas containing the PFAS evaporated by the sulfuric acid processing tub 12. The cooling apparatus 13 collects the gas while separating the gas into a low molecular gas, which is a gaseous component, and a hydrocarbon (HC) extract liquid, which is a liquid component. As shown in FIG. 2, when the gas from the sulfuric acid processing tub 12 is cooled in a cooling unit 131 of the cooling apparatus 13, the liquefied gas is collected as the HC extract liquid, and the low molecular gas that has not been condensed is also collected. Since the gas generated from the sulfuric acid processing tub 12 is processed in the nitrogen atmosphere, the gas is a mixed gas with the nitrogen. Since the processing amount of the mixed gas containing a large amount of nitrogen is increased in the subsequent detoxifying apparatus 14, the low molecular gas that has not been condensed in the cooling apparatus 13 may be concentrated while separating it into nitrogen and other substances by using a nano-sub ceramic filter, for example.

Various types of organic gases and other gases are discharged from the sulfuric acid processing tub 12 described above. The PFAS such as the PAG is also discharged as a gas. It may be considered to directly introduce these gases into the detoxifying apparatus 14. For a gas that becomes a liquid at a room temperature, however, transportability thereof can be improved by once liquefying it in the cooling apparatus 13. In addition, if the gas is carried without being liquefied, a puddle of a liquid may be formed in the middle of a pipeline, which is difficult to control. The PFAS is contained in both the liquefied HC extract liquid and the non-condensed low molecular gas. The HC extract liquid and the low molecular gas are introduced into the detoxifying apparatus 14. Also, in order to further improve the transportability of the gas, the whole gas including the low molecular gas may be liquefied and then introduced into the detoxifying apparatus.

The detoxifying apparatus 14 is configured to detoxify the substances after being processed by the cooling apparatus 13. The detoxifying apparatus 14 may be a combustion eliminator configured to combust and eliminate the substances after being processed by the cooling apparatus 13. The detoxifying apparatus 14 incinerates the HC extract liquid and the low molecular gas introduced from the cooling apparatus 13. Since most of the HC extract liquid is hydrocarbon, it can be combusted as a fuel. Further, since a considerable amount of the low molecular gas is hydrocarbon having 10 or less carbon atoms, it can also be combusted as a fuel. Conventionally, a propane gas or a city gas is used as the fuel in a combustion eliminator. By using the HC extract liquid and the like as a fuel as described above, the amount of the propane gas or the like can be reduced.

Furthermore, the detoxifying apparatus 14 may simultaneously combust and eliminate the exhaust gas introduced from the etching apparatus 113, the exhaust gas introduced from the film forming apparatus 114, and the acid waste gas introduced from the cleaning apparatus 112. These gases are exhaust gases containing the PFAS used in the respective apparatuses. By simultaneously combusting and eliminating these gases, the amount of the propane gas or the like can be further reduced. Further, during the combustion elimination, electric power may be generated by combusting the gases with an internal combustion engine such as a gas turbine. A detoxified gas such as carbon dioxide may be collected and used for synthesis of an organic substance such as methanol or formic acid. In addition, the detoxifying apparatus 14 may be a subcritical processing apparatus configured to perform a subcritical processing on the substances processed by the cooling apparatus 13, or a supercritical processing apparatus configured to perform a supercritical processing on the substances processed by the cooling apparatus 13. Further, the detoxified waste gases may be processed into F ion-containing scrubber water and a waste gas through a scrubber device (a device configured to wash the exhaust gas with water, neutralize the exhaust gas with a chemical liquid, or adsorb the exhaust gas to discharge it into the atmosphere).

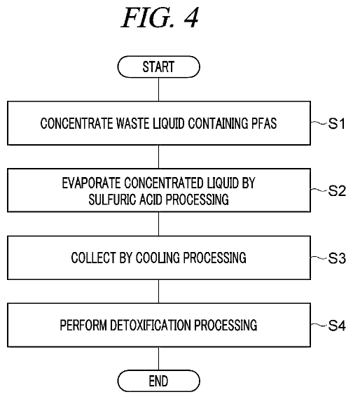

Now, a PFAS detoxification processing performed in the PFAS detoxification system 1 will be explained with reference to FIG. 4. FIG. 4 is a flowchart illustrating the PFAS detoxification processing.

As shown in FIG. 4, in the PFAS detoxification system 1, the resist waste liquid containing the PFAS discharged from the lithography apparatus 111 of the semiconductor manufacturing apparatus 100 is concentrated in the concentrator 11 (process S1, a concentration process). In the concentration process, the resist waste liquid is concentrated, and the solvent contained in the resist waste liquid may be separated.

Subsequently, in the sulfuric acid processing tub 12, the concentrated liquid from the concentrator 11 is decomposed with the SPM waste liquid (or the concentrated sulfuric acid waste liquid) from the cleaning apparatus 112 to be evaporated (process S2, a chemical liquid treatment process). In the chemical liquid treatment process, the concentrated liquid may be dripped onto the inclined member 122 which is continuous with the sulfuric acid reservoir 121 in which the SPM waste liquid is stored and which extends in the inclined shape. In addition, in the chemical liquid treatment process, a predetermined amount of SPM waste liquid from the cleaning apparatus 112 may be added and mixed with the concentrated liquid in the concentrated liquid reservoir 125 storing the concentrated liquid therein, and the mixed liquid may flow into the sulfuric acid reservoir 121 via the inclined member 122.

Thereafter, in the cooling apparatus 13, the gas containing the PFAS evaporated by the sulfuric acid processing tub 12 is liquefied and collected (process S3, a collecting process). In the collecting process, the gas is collected while being separated into the gas component (the low molecular gas) and the liquid component (the HC extract liquid).

Subsequently, in the detoxifying apparatus 14, a detoxification processing is performed to detoxify the substances (the low molecular gas and the HC extract liquid) after being processed in the collecting process (process S4, a detoxifying process). In the detoxifying process, the substances after being processed in the collecting process may be subjected to the combustion elimination or the subcritical processing. Further, in the detoxifying process, the combustion elimination processing may be performed by using the exhaust gases containing the PFAS used in the etching apparatus 113 and the film forming apparatus 114.

Now, effects of the PFAS detoxification system 1 according to the present exemplary embodiment will be described.

The PFAS detoxification system 1 according to the present exemplary embodiment includes the concentrator 11 configured to concentrate the waste liquid containing the PFAS, discharged from the semiconductor manufacturing apparatus 100, and the sulfuric acid processing tub 12 configured to decompose and evaporate the concentrated liquid concentrated by the concentrator 11 with the liquid containing the concentrated sulfuric acid. In addition, the PFAS detoxification system 1 includes the cooling apparatus 13 configured to liquefy and collect the gas evaporated by the sulfuric acid processing tub 12.

In the PFAS detoxification system 1 according to the present exemplary embodiment, after the waste liquid containing the PFAS is concentrated, the concentrated liquid is decomposed and evaporated with the liquid (the SPM waste liquid or the concentrated sulfuric acid) containing the concentrated sulfuric acid, and the evaporated gas is liquefied. In this way, as the concentrated liquid is mixed into the liquid containing the concentrated sulfuric acid, the polymer or the solvent has low molecular weight by the decomposition reaction of the dehydration reaction, and the organic fluorine compound is evaporated. As the mixed liquid is degassed by the organic matter reaction, it becomes difficult for the liquid to foam in the subsequent processing, so that the subsequent processing can be performed easily. Further, as the evaporated gas is liquefied, the transportability of the substance subjected to the detoxification processing can be improved. As described above, in the PFAS detoxification system 1 according to the present exemplary embodiment, the PFAS detoxification processing can be smoothly performed.

The cooling apparatus 13 may collect the gas while separating it into the gas component and the liquid component. In this way, the substance that can be liquefied is liquefied to improve the transportability, and the low molecular gas (gas component) that has not been liquefied is collected, so that the substances containing the PFAS can be appropriately collected.

The PFAS detoxification system 1 according to the present exemplary embodiment may be further equipped with the detoxifying apparatus 14 configured to detoxify the substance obtained after being processed by the cooling apparatus 13. Therefore, in the PFAS detoxification system 1, the PFAS detoxification processing can be appropriately performed.

The detoxifying apparatus 14 may be a combustion eliminator configured to combust and eliminate the substances obtained after being processed by the cooling apparatus 13. With this configuration, the PFAS detoxification processing can be appropriately carried out.

The detoxifying apparatus 14 may be a subcritical processing apparatus configured to perform the subcritical processing on the substance obtained after being processed by the cooling apparatus 13. With this configuration, the PFAS detoxification processing can be appropriately performed.

The concentrator 11 may concentrate the waste liquid, and separate the solvent contained in the waste liquid. By separating the solvent contained in the waste liquid in this way, it becomes possible to reuse this solvent as the recycled solvent or sell it to the recovery company.

The semiconductor manufacturing apparatus 100 may include at least the lithography apparatus 111 and the cleaning apparatus 112. The concentrator 11 may concentrate, as the waste liquid containing the PFAS, the substrate processing waste liquid in the lithography apparatus 111, and the sulfuric acid processing tub 12 may use, as the liquid containing the concentrated sulfuric acid, the liquid (the SPM waste liquid or the like) containing the concentrated sulfuric acid which is wasted from the cleaning apparatus 112. As the concentrator 11 concentrates the substrate processing waste liquid in the lithography apparatus 111, the resist waste liquid containing a large amount of PFAS or the like can be subjected to the detoxification processing. Further, since the SPM waste liquid of the cleaning apparatus 112 is used, the SPM waste liquid of the cleaning apparatus 112 originally supposed to be wasted can be effectively used. In addition, since the SPM waste liquid of the cleaning apparatus 112 also contains the PFAS, the organic fluorine compound contained in the SPM waste liquid can also be detoxified appropriately.

The semiconductor manufacturing apparatus 100 may include at least the etching apparatus 113 and the film forming apparatus 114, and the detoxifying apparatus 14 may perform the combustion elimination processing by using the PFA-containing exhaust gases used in the etching apparatus 113 and the film forming apparatus 114. By using the exhaust gases in this way, the amount of the fuel introduced into the detoxifying apparatus 14 can be reduced, so that the total discharge amount of CO 2 can be suppressed, and the enlargement of the incineration facility can be avoided. Further, the PFAS contained in the exhaust gases may be detoxified.

The sulfuric acid processing tub 12 has the sulfuric acid reservoir 121 in which the SPM waste liquid is stored, and the inclined member 122 continuous with the sulfuric acid reservoir 121 and extending in the inclined shape. The inclined member 122 may receive the concentrated liquid dripped thereon and guide this concentrated liquid toward the sulfuric acid reservoir 121. In this way, as the concentrated liquid is dripped onto the inclined member 122, the occurrence of the violent reaction between the SPM waste liquid and the concentrated liquid can be suppressed.

The sulfuric acid processing tub 12 further includes the concentrated liquid reservoir 125 in which the concentrated liquid is stored. In the concentrated liquid reservoir 125, a predetermined amount of SPM waste liquid may be added to be mixed with the concentrated liquid, and the mixed liquid may flow into the sulfuric acid reservoir 121 via the inclined member 122. Accordingly, after the SPM waste liquid and the concentrated liquid are mixed to the extent that no violent reaction therebetween occurs in the concentrated liquid reservoir 125, the mixed liquid flows into the sulfuric acid reservoir 121 via the inclined member 122. As a result, the reaction between the SPM waste liquid and the concentrated liquid can be effectively accelerated.

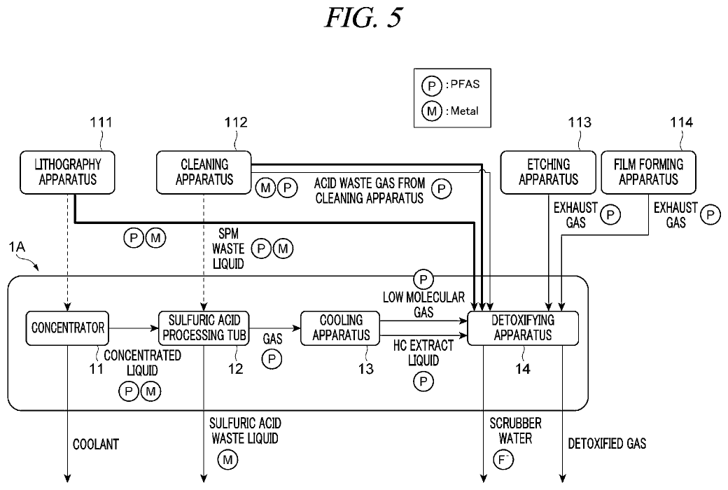

So far, the exemplary embodiment has been described. However, the present exemplary embodiment is not limited to the above. For example, as in a PFAS detoxification system 1A shown in FIG. 5, there may be adopted a configuration in which the exhaust gas from the lithography apparatus 111 is directly introduced into the detoxifying apparatus 14. The exhaust gas is a PFAS-containing gas generated by, for example, film formation/development/heating/light irradiation. In this configuration as well, when a PFAS-containing liquid is generated from some of the processings in the lithography apparatus 111, the PFAS-containing liquid may be introduced into the concentrator 11. Further, as illustrated in FIG. 5, in case that the cleaning apparatus 112 performs a dry processing, i.e., a processing by a gas, the exhaust gas which is the PFAS-containing gas may be directly introduced into the detoxifying apparatus 14. Additionally, in the detoxifying apparatus 14, the detoxification processing may be performed including these exhaust gases.

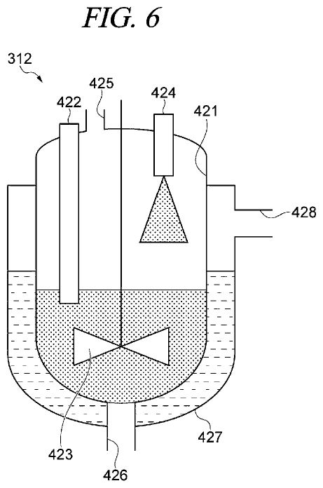

FIG. 6 is a schematic diagram of a sulfuric acid processing tub 312 according to a modification example. The sulfuric acid processing tub 312 includes a sulfuric acid reservoir 421 (first reservoir), an SPM nozzle 422, an agitator 423, a concentrated liquid nozzle 424 (concentrated liquid discharge unit), and a gas outlet port 425 (exhaust unit). The sulfuric acid processing tub 312 also has an SPM outlet port 426 (drain port), a cooling water passage 427, and a gas outlet port 428.

The sulfuric acid reservoir 421 is a storage that stores therein the SPM waste liquid, which is a liquid containing the concentrated sulfuric acid to be wasted. Here, the liquid stored in the sulfuric acid reservoir 421 is not limited to the SPM waste liquid, and may be other liquids containing the concentrated sulfuric acid. The SPM nozzle 422 is a nozzle configured to supply the SPM waste liquid discharged from the cleaning apparatus into the sulfuric acid reservoir 421. The agitator 423 is configured to agitate the SPM waste liquid stored in the sulfuric acid reservoir 421. The concentrated liquid nozzle 424 is configured to introduce the above-described concentrated liquid into the sulfuric acid reservoir 421 in the form of mist. The concentrated liquid nozzle 424 sprays the concentrated liquid in the form of mist together with an inert gas (for example, a nitrogen gas). In this way, by spraying the concentrated liquid in the form of mist, the concentrated liquid of the resist can be added slowly and intermittently, so that the safety can be improved (as will be described in detail later). In addition, by spraying the concentrated liquid in the form of mist, the interface is minimized, so that the drying can be accelerated. Further, by using the nitrogen gas as the inert gas, the ignition in the reaction can be suppressed. However, the concentrated liquid nozzle 424 may not necessarily spray the concentrated liquid in the form of mist, but may be configured to send it to the sulfuric acid reservoir 421 as a normal liquid.

The gas outlet port 425 is an exhaust unit through which the gas collected in the sulfuric acid reservoir 421 is exhausted. The SPM outlet port 426 is a drain port through which the SPM waste liquid is drained from the sulfuric acid reservoir 421. The cooling water passage 427 is formed so as to surround bottom and side surfaces of the sulfuric acid reservoir 421, and is configured to cool the sulfuric acid reservoir 421 by cooling water (coolant) flowing therein. The gas outlet port 428 is provided on the upper end side of the cooling water passage 427, and serves as an exhaust unit through which a gas of the evaporated cooling water is exhausted.

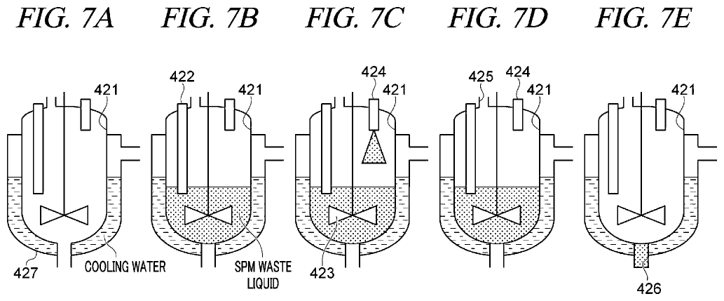

Hereinafter, processings (first to third processings) of the SPM waste liquid using the sulfuric acid processing tub 312 described above will be explained with reference to FIG. 7A to FIG. 9E. Here, when the concentrated liquid is supplied into sulfuric acid hydrogen peroxide, an organic matter has low molecular weight by intramolecular and intermolecular dehydration reactions. The sulfuric acid hydrogen peroxide is more reactive than sulfuric acid and is therefore more dangerous. Further, since the density (1.84) of the sulfuric acid is heavier than that of the concentrated liquid, the sulfuric acid hydrogen peroxide is not mixed with the concentrated liquid well as it is. Although they react actively at the interface, they are not mixed with each other, so sudden boiling like explosion may occur. Further, in consideration of the fact that the generated gas contains a gas having an autoignition point of 200° C. or less, there is a risk of ignition because the temperature of the concentrated sulfuric acid reaches about 290° C. The first to third processings described above are processes conducted to perform the process of adding the concentrated liquid to the SPM waste liquid more safely.

FIG. 7A to FIG. 7E are diagrams showing images of the first processing in the sulfuric acid processing tub 312. In the first processing, first, the sulfuric acid reservoir 421 is emptied, and the cooling water is stored in the cooling water passage 427, as illustrated in FIG. 7A. Subsequently, as shown in FIG. 7B, the SPM waste liquid is stored in the sulfuric acid reservoir 421 via the SPM nozzle 422. Then, as shown in FIG. 7C, the concentrated liquid of the resist is sprayed together with the nitrogen gas in the form of mist by the concentrated liquid nozzle 424. This spraying of the concentrated liquid is performed slowly and intermittently. Since the concentrated liquid has a heavier specific gravity than the sulfuric acid, it is supplied in such a state as floating on the surface of the SPM waste liquid. In this state, agitation is performed slowly by the agitator 423. As a result, the concentrated liquid stays on the surface of the SPM waste liquid. Although oxidation and dehydration reactions vigorously take place on the interfaces of the concentrated liquid and the SPM waste liquid, a component inside the concentrated liquid that is not in contact with the SPM waste liquid receives reaction heat to be evaporated without reaction. Since the evaporated solvent is discharged without coming into contact with the SPM waste liquid again, it is not decomposed and thus can be used as the fuel in the combustion eliminator.

Then, as depicted in FIG. 7D, if the liquid turns brown because the ability of the hydrogen peroxide in the SPM waste liquid is weakened so that carbonization of the organic matter proceeds, the spraying of the concentrated liquid from the concentrated liquid nozzle 424 is ended. Further, vacuum evacuation may be performed such that the gas discharge from the gas outlet port 425 is accelerated. If the gas discharge is completed, the liquid containing the sulfuric acid is drained from the SPM outlet port 426 as shown in FIG. 7E, so that the state of FIG. 7A is obtained again.

In the above processing, in the state that the liquid is not turned brown, carbon is released as carbon dioxide. If a combustible substance is burned in the process in the sulfuric acid processing tub 312, it cannot be utilized as the fuel for the combustion when the combustion elimination is performed. However, in subcritical decomposition, since the combustible substance may interfere with the decomposition, it is desirable to burn the combustible substance in the sulfuric acid processing tub 312.

In the above-described first processing, since the concentrated liquid is slowly introduced by being sprayed in the form of mist, safety is very high (higher than that of the second processing to be described below). Further, since the evaporated solvent component is not decomposed, this evaporated solvent component can be used as the fuel in the combustion eliminator.

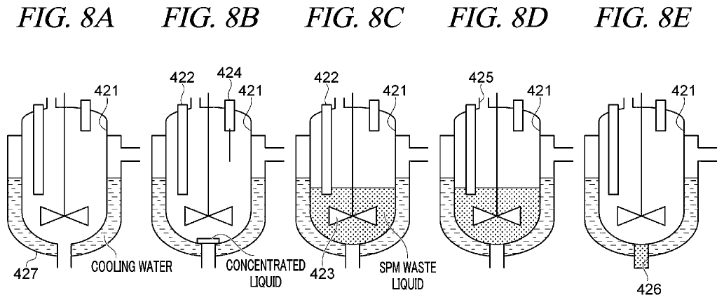

FIG. 8A to FIG. 8E are diagrams illustrating images of the second processing in the sulfuric acid processing tub 312. In the second processing, first, the sulfuric acid reservoir 421 is emptied, and the cooling water is stored in the cooling water passage 427, as illustrated in FIG. 8A. Subsequently, the concentrated liquid of the resist is supplied into the sulfuric acid reservoir 421 from the concentrated liquid nozzle 424, as depicted in FIG. 8B. In this case, the concentrated liquid nozzle 424 may supply the concentrated liquid as the normal liquid instead of spraying it in the form of mist. Then, as shown in FIG. 8C, the SPM waste liquid is stored in the sulfuric acid reservoir 421 via the SPM nozzle 422. As a result, the processing of the concentrated liquid and the SPM waste liquid progresses at once. In this state, the agitation is performed rapidly by the agitator 423.

Then, the processing is put on standby until the gas collected in the sulfuric acid reservoir 421 is exhausted from the gas outlet port 425 and the reaction subsidies so that the discharge of the gas is ended. Alternatively, the exhaust of the gas is performed in a vacuum state. As a result, as shown in FIG. 8D, the ability of the hydrogen peroxide in the SPM waste liquid is weakened, so the carbonization of the organic matter proceeds and the liquid turns brown. Finally, as illustrated in FIG. 8E, the liquid containing the sulfuric acid is drained from the SPM outlet port 426 as shown in FIG. 8E, so that the state of FIG. 8A is obtained again.

In the above processing, in the state that the liquid is not turned brown, carbon is released as carbon dioxide. If a combustible substance is burned in the process in the sulfuric acid processing tub 312, it cannot be utilized as the fuel for combustion when the combustion elimination is performed. However, since the combustible substance may interfere with the decomposition during the subcritical decomposition, it is desirable to burn the combustible substance in the sulfuric acid processing tub 312.

In the above-described second processing, the concentrated liquid is first added and then the SPM waste liquid is added. Thus, the evaporated solvent component is also allowed to undergo the oxidation and dehydration reactions with the ambient SPM waste liquid. Accordingly, a higher-speed processing can be achieved, as compared to the first processing described above, so that more heat is generated. Since the rate of intramolecular dehydration increases, a large amount of hydrocarbon gas having a low molecular weight is discharged.

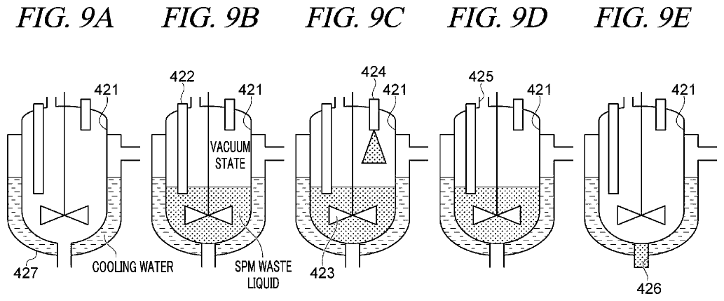

FIG. 9A to FIG. 9E are diagrams showing images of the third processing in the sulfuric acid processing tub 312. In the third processing, first, the sulfuric acid reservoir 421 is emptied, and the cooling water passage 427 is filled with the cooling water, as illustrated in FIG. 9A. Subsequently, as shown in FIG. 9B, the SPM waste liquid is stored in the sulfuric acid reservoir 421 via the SPM nozzle 422. In the third processing, in this state, the inside of the sulfuric acid reservoir 421 is maintained in a vacuum state until the component of the hydrogen peroxide evaporates. At this time, water is added when necessary, so the temperature of the SPM increases. Further, the agitation is performed slowly by the agitator 423.

Subsequently, as shown in FIG. 9C, the concentrated liquid of the resist is sprayed together with the nitrogen gas in the form of mist by the concentrated liquid nozzle 424. This spraying of the concentrated liquid is performed slowly and intermittently. Since the concentrated liquid has a heavier specific gravity than the sulfuric acid, it is supplied in such a state as floating on the surface of the SPM waste liquid. In this state, the agitation is performed slowly by the agitator 423. As a result, the concentrated liquid stays on the surface of the SPM waste liquid. Although the oxidation and dehydration reactions vigorously take place on the interfaces of the concentrated liquid and the SPM waste liquid, the component inside the concentrated liquid that is not in contact with the SPM waste liquid receives reaction heat to be evaporated without reacting. Since the evaporated solvent is discharged without coming into contact with the SPM waste liquid again, it is not decomposed and thus can be used as the fuel in the combustion eliminator.

Then, as depicted in FIG. 9D, if the liquid turns brown because the ability of the hydrogen peroxide in the SPM waste liquid is weakened so that the carbonization of the organic matter proceeds, the spraying of the concentrated liquid from the concentrated liquid nozzle 424 is ended. Further, the vacuum evacuation may be performed so that the gas discharge from the gas outlet port 425 may be accelerated. If the gas discharge is completed, the liquid containing the sulfuric acid is drained from the SPM outlet port 426 as shown in FIG. 9E, so that the state of FIG. 9A is obtained again.

In the above-described third processing, by inactivating the hydrogen peroxide in the state that the SPM waste liquid is stored in the sulfuric acid reservoir 421, the decomposition reaction of the combustible substance can be minimized. Thus, the third processing has the highest safety among the first to third processings.

Finally, various exemplary embodiments included in the present disclosure are described in the following [E1] to [E26].

[E1]

A processing system includes a concentrating unit configured to concentrate a waste liquid containing an organic fluorine compound, discharged from a semiconductor manufacturing apparatus; and a chemical liquid processing unit configured to decompose and evaporate a concentrated liquid concentrated by the concentrating unit with a liquid containing concentrated sulfuric acid. Further, the processing system includes a collecting unit configured to liquefy and collect a gas evaporated by the chemical liquid processing unit.

[E2]

The processing system of [E1], wherein the collecting unit collects the gas while separating the gas into a gas component and a liquid component.

[E3]

The processing system of [E1] or [E2] further including a detoxifying unit configured to detoxify a substance obtained after being processed by the collecting unit.

[E4]

The processing system of [E3], wherein the detoxifying unit is a combustion eliminator configured to combust and eliminate the substance obtained after being processed by the collecting unit.

[E5]

The processing system of [E3], wherein the detoxifying unit is a subcritical processing apparatus configured to perform a subcritical processing or a supercritical processing apparatus configured to perform a supercritical processing on the substance obtained after being processed by the collecting unit.

[E6]

The processing system of any one of [E1] to [E5], wherein the concentrating unit concentrates the waste liquid, and separates a solvent contained in the waste liquid.

[E7]

The processing system of any one of [E1] to [E6], wherein the semiconductor manufacturing apparatus includes at least a lithography apparatus and a cleaning apparatus, the concentrating unit concentrates, as the waste liquid containing the organic fluorine compound, a substrate processing waste liquid in the lithography apparatus, and the chemical liquid processing unit uses, as the liquid containing the concentrated sulfuric acid, a liquid containing concentrated sulfuric acid wasted from the cleaning apparatus.

[E8]

The processing system of [E4], wherein the semiconductor manufacturing apparatus includes at least an etching apparatus and a film forming apparatus, and the combustion eliminator performs a combustion elimination processing by using an exhaust gas containing organic fluorine compound used in the etching apparatus and the film forming apparatus.

[E9]

The processing system of [E7], wherein the chemical liquid processing unit includes a first reservoir in which the liquid containing the concentrated sulfuric acid wasted is stored, and an inclined member which is continuous with the first reservoir and which extends in an inclined shape, and the inclined member receives the concentrated liquid dripped thereon, and guides the received concentrated liquid toward the first reservoir.

[E10]

The processing system of [E9], wherein the chemical liquid processing unit further includes a second reservoir in which the concentrated liquid is stored, and a predetermined amount of the liquid containing the concentrated sulfuric acid wasted is added in the second reservoir to be mixed with the concentrated liquid, and a mixed liquid flows into the first reservoir via the inclined member.

[E11]

A processing method includes concentrating a waste liquid containing an organic fluorine compound, discharged from a semiconductor manufacturing apparatus; and decomposing and evaporating a concentrated liquid concentrated in the concentrating of the waste liquid with a liquid containing concentrated sulfuric acid. Further, the processing method includes liquefying and collecting a gas evaporated in the decomposing and the evaporating of the concentrated liquid.

[E12]

The processing method of [E11], wherein in the liquefying and the collecting of the gas, the gas is collected while being separated into a gas component and a liquid component.

[E13]

The processing method of [E11] or [E12] further including detoxifying a substance obtained after being processed in the liquefying and the collecting of the gas.

[E14]

The processing method of [E13], wherein, in the detoxifying of the substance, a combustion elimination is performed on the substance obtained after being processed in the liquefying and the collecting of the gas.

[E15]

The processing method of [E13], wherein, in the detoxifying of the substance, a subcritical processing is performed on the substance obtained after being processed in the liquefying and the collecting of the gas.

[E16]

The processing method of any one of [E11] to [E15], wherein, in the concentrating of the waste liquid, the waste liquid is concentrated, and a solvent contained in the waste liquid is separated.

[E17]

The processing method of any one of [E11] to [E16], wherein, in the concentrating of the waste liquid, a substrate processing waste liquid in a lithography apparatus is concentrated as the waste liquid containing the organic fluorine compound, and, in the decomposing and the evaporating of the concentrated liquid, a liquid containing concentrated sulfuric acid wasted from a cleaning apparatus is used as the liquid containing the concentrated sulfuric acid.

[E18]

The processing method of [E14], wherein, in the detoxifying of the substance, a combustion elimination processing is performed by using an exhaust gas containing organic fluorine compound used in an etching apparatus and a film forming apparatus.

[E19]

The processing method of [E17], wherein, in the decomposing and the evaporating of the concentrated liquid, the concentrated liquid is dripped on an inclined member which is continuous with a first reservoir and which extends in an inclined shape.

[E20]

The processing method of [E19], wherein, in the decomposing and the evaporating of the concentrated liquid, a predetermined amount of the liquid containing the concentrated sulfuric acid wasted is added in a second reservoir to be mixed with the concentrated liquid, and a mixed liquid flows into the first reservoir via the inclined member.

[E21]

The processing system of [E7], wherein the chemical liquid processing unit includes a first reservoir in which the liquid containing the concentrated sulfuric acid wasted is stored, and an inclined member which is continuous with the first reservoir and which extends in an inclined shape.

[E22]

The processing system of [E21], wherein the concentrated liquid discharge unit sprays the concentrated liquid in a form of mist together with an inert gas.

[E23]

The processing system of [E22], wherein the chemical liquid processing unit includes an exhaust unit through which a gas collected in the first reservoir is exhausted, and a drain port through which the liquid containing the concentrated sulfuric acid is drained, and
wherein, in a processing performed in the chemical liquid processing unit,
supplying the liquid containing the concentrated sulfuric acid into the first reservoir;
spraying, by the concentrated liquid discharge unit, the concentrated liquid into the first reservoir in the form of mist together with the inert gas;
exhausting, by the exhaust unit, the gas collected in the first reservoir; and
draining the liquid containing the concentrated sulfuric acid from the drain port are performed in sequence.

[E24]

The processing system of [E7], wherein the chemical liquid processing unit includes a first reservoir in which the liquid containing the concentrated sulfuric acid wasted is stored, a concentrated liquid discharge unit configured to discharge the concentrated liquid into the first reservoir, an exhaust unit through which a gas collected in the first reservoir is exhausted, and a drain port through which the liquid containing the concentrated sulfuric acid is drained, and
wherein, in a processing performed in the chemical liquid processing unit,
supplying, by the concentrated liquid discharge unit, the concentrated liquid into the first reservoir;
supplying the liquid containing the concentrated sulfuric acid into the first reservoir;
exhausting, by the exhaust unit, the gas collected in the first reservoir; and
draining the liquid containing the concentrated sulfuric acid from the drain port are performed in sequence.

[E25]

The processing system of [E23], wherein the liquid containing the concentrated sulfuric acid is a SPM waste liquid.

[E26]

The processing system of [E25], wherein in the processing performed in the chemical liquid processing unit,
an inside of the first reservoir is maintained in a vacuum state until a component of hydrogen peroxide evaporates in a period after the liquid containing the concentrated sulfuric acid is supplied into the first reservoir and before the concentrated liquid is sprayed.

[E27]

The processing system of [E21] or [E22], wherein the inert gas is a nitrogen gas.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting. The scope of the inventive concept is defined by the following claims and their equivalents rather than by the detailed description of the exemplary embodiments. It shall be understood that all modifications and embodiments conceived from the meaning and scope of the claims and their equivalents are included in the scope of the inventive concept.

According to the present disclosure, it is possible to smoothly perform the detoxification processing of the organic fluorine compound.

We claim:

1. A processing system, comprising:
a concentrating unit configured to concentrate a waste liquid containing an organic fluorine compound, discharged from a semiconductor manufacturing apparatus;
a chemical liquid processing unit configured to decompose and evaporate a concentrated liquid concentrated by the concentrating unit with a liquid containing concentrated sulfuric acid; and
a collecting unit configured to liquefy and collect a gas evaporated by the chemical liquid processing unit.

2. The processing system of claim 1,
wherein the collecting unit collects the gas while separating the gas into a gas component and a liquid component.

3. The processing system of claim 1, further comprising:
a detoxifying unit configured to detoxify a substance obtained after being processed by the collecting unit.

4. The processing system of claim 3,
wherein the detoxifying unit is a combustion eliminator configured to combust and eliminate the substance obtained after being processed by the collecting unit.

5. The processing system of claim 3,
wherein the detoxifying unit is a subcritical processing apparatus configured to perform a subcritical processing on the substance obtained after being processed by the collecting unit.

6. The processing system of claim 1,
wherein the concentrating unit concentrates the waste liquid, and separates a solvent contained in the waste liquid.

7. The processing system of claim 1,
wherein the semiconductor manufacturing apparatus includes at least a lithography apparatus and a cleaning apparatus,
the concentrating unit concentrates, as the waste liquid containing the organic fluorine compound, a substrate processing waste liquid in the lithography apparatus, and
the chemical liquid processing unit uses, as the liquid containing the concentrated sulfuric acid, a liquid containing concentrated sulfuric acid wasted from the cleaning apparatus.

8. The processing system of claim 4,
wherein the semiconductor manufacturing apparatus includes at least an etching apparatus and a film forming apparatus, and
the combustion eliminator performs a combustion elimination processing by using an exhaust gas containing organic fluorine compound used in the etching apparatus and the film forming apparatus.

9. The processing system of claim 7,
wherein the chemical liquid processing unit includes a first reservoir in which the liquid containing the concentrated sulfuric acid wasted is stored, and an inclined member which is continuous with the first reservoir and which extends in an inclined shape, and
the inclined member receives the concentrated liquid dripped thereon, and guides the received concentrated liquid toward the first reservoir.

10. The processing system of claim 9,
wherein the chemical liquid processing unit further includes a second reservoir in which the concentrated liquid is stored, and
a predetermined amount of the liquid containing the concentrated sulfuric acid wasted is added in the second reservoir to be mixed with the concentrated liquid, and a mixed liquid flows into the first reservoir via the inclined member.

11. The processing system of claim 7,
wherein the chemical liquid processing unit includes a first reservoir in which the liquid containing the concentrated sulfuric acid wasted is stored, and a concentrated liquid discharge unit configured to discharge the concentrated liquid into the first reservoir in a form of mist.

12. The processing system of claim 11,
wherein the concentrated liquid discharge unit sprays the concentrated liquid in the form of mist together with an inert gas.

13. The processing system of claim 12,
wherein the chemical liquid processing unit includes an exhaust unit through which a gas collected in the first reservoir is exhausted, and a drain port through which the liquid containing the concentrated sulfuric acid is drained, and
wherein, in a processing performed in the chemical liquid processing unit,
supplying the liquid containing the concentrated sulfuric acid into the first reservoir;
spraying, by the concentrated liquid discharge unit, the concentrated liquid into the first reservoir in the form of mist together with the inert gas;
exhausting, by the exhaust unit, the gas collected in the first reservoir; and
draining the liquid containing the concentrated sulfuric acid from the drain port are performed in sequence.

14. The processing system of claim 7,
wherein the chemical liquid processing unit includes a first reservoir in which the liquid containing the concentrated sulfuric acid wasted is stored, a concentrated liquid discharge unit configured to discharge the concentrated liquid into the first reservoir, an exhaust unit through which a gas collected in the first reservoir is exhausted, and a drain port through which the liquid containing the concentrated sulfuric acid is drained, and
wherein, in a processing performed in the chemical liquid processing unit,
supplying, by the concentrated liquid discharge unit, the concentrated liquid into the first reservoir;
supplying the liquid containing the concentrated sulfuric acid into the first reservoir;
exhausting, by the exhaust unit, the gas collected in the first reservoir; and
draining the liquid containing the concentrated sulfuric acid from the drain port are performed in sequence.

15. The processing system of claim 13,
wherein the liquid containing the concentrated sulfuric acid is a SPM waste liquid.

16. The processing system of claim 15,
wherein, in the processing performed in the chemical liquid processing unit,
an inside of the first reservoir is maintained in a vacuum state until a component of hydrogen peroxide evaporates in a period after the liquid containing the concentrated sulfuric acid is supplied into the first reservoir and before the concentrated liquid is sprayed.

17. The processing system of claim 12,
wherein the inert gas is a nitrogen gas.

18. A processing method, comprising:
concentrating a waste liquid containing an organic fluorine compound, discharged from a semiconductor manufacturing apparatus;
decomposing and evaporating a concentrated liquid concentrated in the concentrating of the waste liquid with a liquid containing concentrated sulfuric acid; and
liquefying and collecting a gas evaporated in the decomposing and the evaporating of the concentrated liquid.

19. The processing method of claim 18,
wherein, in the liquefying and the collecting of the gas, the gas is collected while being separated into a gas component and a liquid component.

20. The processing method of claim 18, further comprising:
detoxifying a substance obtained after being processed in the liquefying and the collecting of the gas.
